(19) United States
(12) Patent Application Publication
(10) Pub. No.: US 2022/0114276 A1
(43) Pub. Date: Apr. 14, 2022

(54) CONTROLLING A DATA NETWORK WITH RESPECT TO A USE OF A DISTRIBUTED DATABASE

(71) Applicant: Siemens Aktiengesellschaft, München (DE)

(72) Inventor: Dominik Sachsenhauser, Hahnbach (DE)

(21) Appl. No.: 17/261,978

(22) PCT Filed: Jul. 9, 2019
(86) PCT No.: PCT/EP2019/068409

§ 371 Date: Jan. 21, 2021

(30) Foreign Application Priority Data
Jul. 25, 2018 (EP) 18185507.3

(51) Int. Cl. G06F 21/62; G06F 21/60; G06F 21/64

(52) U.S. Cl. CPC G06F 21/6227; G06F 21/604; G06F 21/64; G06F 21/602

(57) ABSTRACT

The disclosure relates to a control of a data network with respect to a use of a distributed database. In this case, a capacity of computing resources of a plurality of computing units of the data network is acquired. The operation of the data network with respect to the use of the distributed database is controlled as a function of the capacity of the computing resources.

The present patent document is a § 371 nationalization of PCT Application Serial No. PCT/EP2019/068409, filed Jul. 9, 2019, designating the United States, which is hereby incorporated by reference, and this patent document also claims the benefit of European Patent Application No. 18185507.3, filed Jul. 25, 2018, which is also hereby incorporated by reference.

### TECHNICAL FIELD

The present disclosure relates to the control of a data network in order to use this control to implement a distributed database within the data network or to expand a distributed database already existing within the data network.

### BACKGROUND

The document U.S. Pat. No. 8,531,247 B2, the document U.S. Pat. No. 8,892,616 B2, the document U.S. Pat. No. 8,300,811 B2, the document U.S. Pat. No. 9,147,088 B2, the document U.S. Pat. No. 9,584,311 B2, the document EP 2976707 B1, the document EP 2 605 445 B1, the document EP 2 870 565 A1, the document EP 2 891 102 A1, the document WO 2017137256 A1, the document EP 2870565 B1, EP 2891266 B1, the document EP 2961091 A1, the document EP 2961093 A1, the document EP 3028140 B1, the document EP 2930610 B1, the document EP 2940620 B1, the document EP 2899714 A1, the document EP 2981926 A0, the document EP 3125492 B1, the document EP17195125, the document EP17211075, the document EP18178316, the document EP18156084, the document EP18151345, the document EP18167702, the document EP18153594, the document EP18162050, the document EP18178498, the document EP18152117, the document EP18150133, the document EP18169145, the document EP17210647, the document EP18150146, the document EP18167486, the document EP18168670, the document EP18162049, the document EP17203819, the document EP18157168, the document EP18169421, the document EP17210253, the document EP17205224, the document EP18169269, the document EP18169254, the document EP17210288, the document EP18153025, the document EP17200614, the document EP18156308, the document EP17201758, the document EP18156511, the document EP18159485, the document EP17203573, the document EP 17175275, the document EP17186826, the document WO 2018069271 A1, the document PCT/EP2017/082508, the document EP17179823, the document WO 2017050348 A1, the document WO 2018068965 A1 and the document U.S. Pat. No. 8,843,761 B2 are known from the prior art.

Modern security techniques such as VPN (Virtual Private network) or the use of a PKI (Public Key Infrastructure) in DMZs (demilitarized zones) guarantee(s) substantially only security or integrity when transmitting data. If an (external) attacker has overcome these security techniques once and has tampered with data within a data network, it is nowadays virtually impossible to detect this tampering.

### SUMMARY AND DESCRIPTION

Therefore, the object of the present disclosure is to guarantee the integrity (that is to say the truthfulness and correctness of the information) of a data network as comprehensively as possible.

According to the disclosure, this object is achieved by a method for controlling a data network with respect to use of a distributed database, by an apparatus, by a computer program product, and by an electronically readable data storage medium, as disclosed herein. The scope of the present disclosure is defined solely by the appended claims and is not affected to any degree by the statements within this summary. The present embodiments may obviate one or more of the drawbacks or limitations in the related art.

The technology of blockchains or “distributed ledgers” is currently an intensively discussed technology which may be implemented, in particular, as a distributed database system. In addition to applications for decentralized payment systems (e.g., Bitcoin), new possible applications are being developed in the financial industry. In particular, transactions between companies may be achieved thereby in a tamperproof manner without brokers or a clearing center. This enables new business models without a trusted broker, reduces the transaction costs, and new digital services may be flexibly offered without having to set up an infrastructure specifically configured for this purpose and relationships of trust. A transaction data record (or transaction for short) protected by a blockchain includes, for example, program code which may also be referred to as a so-called “smart contract”.

Unless indicated otherwise in the following description, the terms “carry out”, “calculate”, “computer-aided”, “compute”, “determine”, “generate”, “configure”, “reconstruct”, “control”, “assign” and the like may relate to actions and/or processes and/or processing acts which change and/or generate data and/or convert the data into other data, wherein the data are represented or may be present, in particular, as physical variables, for example, as electrical pulses. In particular, the expression “computer” or “apparatus” may be interpreted as broadly as possible in order to cover, in particular, all electronic devices with data-processing properties. Computers may therefore be personal computers, servers, programmable logic controllers (PLC), handheld computer systems, pocket PC devices, mobile radio devices and other communication devices which may process data in a computer-aided manner, processors, and other electronic devices for data processing.

“Computer-aided” may refer to an implementation of the method in which a processor, in particular, carries out at least one method act of the method.

A processor may refer to a machine or an electronic circuit. A processor may be a main processor (Central Processing Unit, CPU), a microprocessor or a microcontroller, for example, an application-specific integrated circuit or a digital signal processor, possibly in combination with a storage unit for storing program instructions, etc. A processor may also be an IC (Integrated Circuit), in particular an FPGA (Field Programmable Gate Array) or an ASIC (Application-Specific Integrated Circuit), or a DSP (Digital Signal Processor) or a graphics processor GPU (Graphic Processing Unit). A processor may also refer to a virtualized processor, a virtual machine, or a soft CPU. It may also be a programmable processor which is equipped with configuration acts for carrying out the method mentioned or is configured using configuration acts in such a manner that the programmable processor implements the features of the method, of the component, of the modules or of other aspects and/or partial aspects of the disclosure.

A “storage unit” or “storage module” and the like may refer to a volatile memory in the form of a main memory (Random-Access Memory, RAM) or a permanent memory such as a hard disk or a data storage medium.

A “module” or a “computing unit” may refer to a processor and/or a storage unit for storing program instructions. For example, the processor is specifically configured to execute the program instructions in such a manner that the processor carries out functions in order to implement or carry out the method or an act of the method. A module may also be a node of the distributed database system, which node implements, for example, the specific functions/features of a corresponding module. The respective modules may also be in the form of separate or independent modules, for example. For this purpose, the corresponding modules may include further elements, for example. These elements are, for example, one or more interfaces (e.g., database interfaces, communication interfaces such as network interface, WLAN interface) and/or an evaluation unit (e.g., a processor) and/or a storage unit. The interfaces may be used to interchange (e.g., receive, transmit, send, or provide) data, for example. Data may be compared, checked, processed, assigned, or calculated in a computer-aided and/or automated manner, for example, by the evaluation unit. Data may be stored, retrieved, or provided in a computer-aided and/or automated manner, for example, by the storage unit.

The term “comprise”, in particular with respect to data and/or information, may refer to (computer-aided) storage of a corresponding item of information or a corresponding data item in a data structure/data record (which is in turn stored in a storage unit, for example).

“Assign”, in particular with respect to data and/or information, may refer to a computer-aided assignment of data and/or information. For example, a second data item is assigned to a first data item for this purpose by a memory address or a unique identifier (UID) by storing the first data item together with the memory address or the unique identifier of the second data item in a data record, for example.

“Provide”, in particular with respect to data and/or information, may refer to a computer-aided provision. Provision is effected, for example, via an interface (e.g., a database interface, a network interface, an interface to a storage unit). Corresponding data and/or information may be transmitted and/or sent and/or retrieved and/or received via this interface, e.g., during provision.

“Provide” may also refer to loading or storing, for example, a transaction with corresponding data. This may be carried out on or by a storage module, for example. “Provide” may also refer to a transfer (or sending or transmission) of corresponding data from one node to another node of the blockchain or the distributed database system (or its infrastructure).

A “smart contract process” may refer to execution of a program code (e.g., the control instructions) in a process by the distributed database system or its infrastructure.

A “checksum”, (e.g., a data block checksum, a data checksum, a node checksum, a transaction checksum, a chaining checksum or the like), may refer to a cryptographic checksum or a cryptographic hash or hash value which is formed or calculated over a data record and/or data and/or one or more of the transactions and/or a section of a data block (e.g., the block header of a block in a blockchain or a data block header of a data block of the distributed database system or only some of the transactions of a data block), in particular by a cryptographic hash function. A checksum may be a checksum or checksums or a hash value or hash values of a hash tree (e.g., Merkle tree, Patricia tree). Furthermore, it may also refer to a digital signature or a cryptographic message authentication code. Cryptographic protection/tamper protection for the transactions and the data (records) stored therein may be achieved, (e.g., on different levels of the database system), by the checksums. If a high degree of security is required, for example, the checksums are generated and checked on the transaction level, for example. If a lower degree of security is required, the checksums are generated and checked on the block level (e.g., over the entire data block or only over a part of the data block and/or some of the transactions), for example.

A “data block checksum” may refer to a checksum which is calculated over some or all transactions of a data block, for example. A node may then check/determine the integrity/authenticity of the corresponding part of a data block by the data block checksum, for example. Additionally or alternatively, the data block checksum may also have been formed, in particular, over transactions of a preceding data block/predecessor data block of the data block. The data block checksum may also be implemented in this case, in particular, by a hash tree, e.g., a Merkle tree or a Patricia tree, wherein the data block checksum is, in particular, the root checksum of the Merkle tree or of a Patricia tree or of a binary hash tree. In particular, transactions are protected by further checksums from the Merkle tree or Patricia tree (e.g., using the transaction checksums), wherein the further checksums, in particular, are leaves in the Merkle tree or Patricia tree. The data block checksum may therefore protect the transactions, for example, by forming the root checksum from the further checksums. The data block checksum may be calculated, in particular, for transactions of a particular data block of the data blocks. In particular, such a data block checksum may be included in a data block following the particular data block in order to chain this following data block to its preceding data blocks, for example, and to therefore make it possible to check an integrity of the distributed database system, in particular. As a result, the data block checksum may undertake the function of the chaining checksum, for example, or may be included in the chaining checksum. The header of a data block (e.g., a new data block or the data block for which the data block checksum was formed) may include the data block checksum, for example.

A “transaction checksum” may refer to a checksum which is formed, in particular, over a transaction of a data block. In addition, a calculation of a data block checksum for a corresponding data block may be accelerated, for example, because transaction checksums which have already been calculated therefor, for example, may be immediately used as leaves, for example, of a Merkle tree.

A “chaining checksum” may refer to a checksum which indicates or references, in particular, a respective data block of the distributed database system the preceding data block of the distributed database system (e.g., referred to as the “previous block hash”, in particular, in the specialist literature). A corresponding chaining checksum is formed, in particular, for the corresponding preceding data block for this purpose. A transaction checksum or the data block checksum of a data block (that is to say an existing data block of the distributed database system) may be used as the chaining checksum in order to chain a new data block to an (existing) data block of the distributed database system. However, it is also possible for a checksum to be formed over a header of the preceding data block or over the entire preceding data block and to be used as a chaining checksum. This may also be calculated, for example, for a plurality of or all preceding data blocks. It is also possible to achieve, for example, the situation in which the chaining checksum is formed over the header of a data block and the data block checksum. However, a respective data block of the distributed database system respectively include a chaining checksum which was calculated or refers to a preceding data block, (e.g., the directly preceding data block), of the respective data block. It is also possible for a corresponding chaining checksum to also be formed only over a part of the corresponding data block (e.g., the preceding data block). This makes it possible to implement a data block, for example, which includes an integrity-protected part and an unprotected part. This makes it possible to implement, for example, a data block whose integrity-protected part is unchangeable and whose unprotected part may also be subsequently changed. In this case, integrity-protected may refer to the fact that a change in integrity-protected data may be determined by a checksum.

The data which are stored, for example, in a transaction of a data block may be provided in different ways, in particular. Instead of the data, e.g., user data such as measurement data or data/ownership conditions relating to assets, a transaction of a data block may include only the checksum for these data, for example. In this case, the corresponding checksum may be implemented in different ways. This may be a corresponding data block checksum of a data block (with the corresponding data) of another database or of the distributed database system, a transaction checksum of a data block with the corresponding data (of the distributed database system or of another database) or a database checksum which was formed over the data.

In addition, the corresponding transaction may also include a reference to or an indication of a storage location (e.g., an address of a file server and details of where the corresponding data may be found on the file server; or an address of another distributed database including the data). The corresponding data may then also be provided, for example, in a further transaction of a further data block of the distributed database system (e.g., if the corresponding data and the associated checksums are included in different data blocks). However, it is also conceivable, for example, for these data to be provided via another communication channel (e.g., via another database and/or a cryptographically secured communication channel).

In addition to the checksum, an additional data record (e.g., a reference to or an indication of a storage location) may also be stored, for example, in the corresponding transaction, which additional data record indicates, in particular, a storage location where the data may be retrieved. This is advantageous, in particular, in order to keep a data size of the blockchain or of the distributed database system as low as possible.

“Security-protected” or “security of data” may refer to protection which is implemented, in particular, by a cryptographic method. For example, this may be implemented by using the distributed database system to provide or transmit or send corresponding data/transactions. This may be achieved by combining the different (e.g., cryptographic) checksums by virtue of the latter interacting synergistically, in particular, in order to improve the security or the cartographic security for the data in the transactions, for example. In other words, “security-protected”, in particular, may refer to “cryptographically protected” and/or “tamperproof”, wherein “tamperproof” may also be referred to as “integrity-protected”.

“Chaining (the) data blocks of a distributed database system” may refer to the fact that data blocks each include an item of information (e.g., chaining checksum) which refers to or references another data block or a plurality of other data blocks of the distributed database system.

“Insertion into the distributed database system” or “storing data in the distributed database” and the like may refer to the fact that a transaction or the transactions or a data block with its transactions is/are transmitted to one or more nodes of a distributed database system, in particular. If these transactions are successfully validated (e.g., by the node(s)), for example, these transactions are chained, in particular as a new data block, to at least one existing data block of the distributed database system. For this purpose, the corresponding transactions are stored in a new data block, for example. In particular, this validation and/or chaining may be carried out by a trusted node (for example, a mining node, a blockchain oracle, or a blockchain platform). In particular, a blockchain platform may refer to a blockchain as a service, as is proposed, in particular, by Microsoft or IBM. In particular, a trusted node and/or a node may respectively store a node checksum (e.g., a digital signature) in a data block (e.g., in that data block which is generated and validated thereby and is then chained) in order to make it possible, in particular, to identify the creator of the data block and/or to make it possible to identify the node. In this case, this node checksum indicates which node has chained the corresponding data block to at least one other data block of the distributed database system, for example.

A “transaction” or “transactions” may refer to a smart contract, a data structure, or a transaction data record each including, in particular, one of the transactions or a plurality of transactions. A “transaction” or “transactions” may refer to the data relating to a transaction of a data block of a blockchain. A transaction may include a program code which implements a smart contract, for example. For example, a transaction may refer to a control transaction and/or a confirmation transaction. Alternatively, a transaction may be a data structure which stores data (for example, the control instructions and/or contract data and/or other data such as video data, user data, measurement data etc.).

“Storing transactions in data blocks”, “storing transactions” and the like may refer to direct or indirect storage. In this case, direct storage may refer to the fact that the corresponding data block (of the distributed database system) or the corresponding transaction (of the distributed database system) includes the respective data. In this case, indirect storage may refer to the fact that the corresponding data block or the corresponding transaction includes a checksum and optionally an additional data record (for example, a reference to or an indication of a storage location) for corresponding data, and the corresponding data are therefore not directly stored in the data block (or the transaction) (that is to say only a checksum for these data instead). In particular, these checksums may be validated, for example, when storing transactions in data blocks, as is explained, for example, under “insertion into the distributed database system”.

A “program code” (for example, a smart contract) may refer to a program instruction or a plurality of program instructions which is/are stored, in particular, in one or more transactions. The program code is executable, in particular, and is executed, for example, by the distributed database system. This may be implemented, for example, by an execution environment (e.g., a virtual machine), wherein the execution environment and the program code may be Turing-complete. The program code may be executed by the infrastructure of the distributed database system. In this case, a virtual machine is implemented by the infrastructure of the distributed database system, for example.

A “smart contract” may refer to an executable program code (see, in particular, definition of “program code”). The smart contract may be stored in a transaction of a distributed database system (e.g., a blockchain), e.g., in a data block of the distributed database system. For example, the smart contract may be executed in the same manner as that explained when defining “program code”, in particular in connection with the disclosure.

“Proof of work” may refer to tackling of a computing-intensive task which may be tackled, in particular, on the basis of the data block content/content of a particular transaction. Such a computing-intensive task is also referred to as a cryptographic puzzle, for example.

A “distributed database system”, which may also be referred to as a distributed database for example, may refer to a database which is distributed in a decentralized manner, a blockchain, a distributed ledger, a distributed storage system, a distributed ledger technology (DLT) based system (DLTS), a tamperproof database system, a cloud, a cloud service, a blockchain in a cloud or a peer-to-peer database. It is also possible to use, for example, different implementations of a blockchain or of a DLTS, for example, a blockchain or a DLTS which by a Directed Acyclic Graph (DAG), a cryptographic puzzle, a hash graph or a combination of the implementation variants mentioned. Different consensus methods (e.g., consensus algorithms) may also be implemented, for example. This may be a consensus method using a cryptographic puzzle, gossip about gossip, virtual voting or a combination of the methods mentioned (e.g., gossip about gossip combined with virtual voting). If a blockchain is used, for example, it may be implemented, in particular, by a Bitcoin-based implementation or an Ethereum-based implementation. A “distributed database system” may refer to a distributed database system, at least some of the nodes and/or devices and/or infrastructure of which are implemented by a cloud. For example, the corresponding components are implemented as nodes/devices in the cloud (e.g., as virtual nodes in a virtual machine). This may be carried out, for example, using VM-ware, Amazon Web services or Microsoft Azure. On account of the high degree of flexibility of the implementation variants explained, partial aspects of the implementation variants mentioned may also be combined with one another, in particular, by virtue of a hash graph being used as a blockchain, for example, wherein the blockchain itself may also be blockless, for example.

If, for example, a Directed Acyclic Graph (DAG) (e.g., IOTA or Tangle) is used, transactions or blocks or nodes of the graph are connected to one another via directed edges, in particular. This means, in particular, that (e.g., all) edges (e.g., always) have the same direction, in a similar manner to that in the case of time, for example. In other words, it is not possible, in particular, to initiate or start the transactions or the blocks or the nodes of the graph in the reverse direction (that is to say counter to the common identical direction). In this case, acyclic means, in particular, that there are no loops when running through the graph.

The distributed database system may be a public distributed database system (e.g., a public blockchain) or a closed (or private) distributed database system (e.g., a private blockchain).

If it is a public distributed database system, for example, this means that new nodes and/or devices may join the distributed database system or are accepted by the latter without proof of authorization or without authentication or without log-on information or without credentials. In particular, the operators of the nodes and/or devices may remain anonymous in such a case.

If the distributed database system is a closed distributed database system, for example, new nodes and/or devices require, for example, valid proof of authorization and/or valid authentication information and/or valid credentials and/or valid log-on information in order to be able to join the distributed database system or to be accepted by the latter.

A distributed database system may also be a distributed communication system for interchanging data. This may be a network or a peer-to-peer network, for example.

A “data block”, which may also be referred to as an “element” or a “block” depending on the context and implementation, may refer to a data block of a distributed database system (e.g., a blockchain or a peer-to-peer database) which is implemented, in particular, as a data structure and may respectively include one of the transactions or a plurality of the transactions. In one implementation, the database (or the database system) may be a DLT-based system (DLTS) or a blockchain and a data block may be a block of the blockchain or of the DLTS. A data block may include details of the size (data size in bytes) of the data block, a data block header, a transaction counter, and one or more transactions. The data block header may include a version, a chaining checksum, a data block checksum, a time stamp, a proof of work, and a nonce (e.g., one-time value, random value, or counter which is used for the proof of work). A data block may also be only a particular storage area or address area of the complete data stored in the distributed database system. For example, blockless distributed database systems, e.g., the IoT Chain (ITC), IOTA and Byteball, may therefore be implemented, for example. In this case, the functionalities of the blocks of a blockchain and of the transactions are combined with one another, in particular, in such a manner that the transactions themselves, for example, protect the sequence or chain of transactions (of the distributed database system) (that is to say are stored in a security-protected manner, in particular). For this purpose, the transactions themselves may be chained to one another, (e.g., using a chaining checksum), by virtue of a separate checksum or the transaction checksum of one or more transactions that may be used as a chaining checksum which is concomitantly stored, when storing a new transaction in the distributed database system, in the corresponding new transaction. In such an embodiment, a data block may also include one or more transactions, for example, wherein, in the simplest case, one data block corresponds to one transaction, for example.

A “nonce” may refer to a cryptographic nonce (abbreviation for: “used only once” or “number used once”). In particular, a nonce denotes an individual combination of numbers or letters which may be used once in the respective context (e.g., transaction, data transmission).

“Preceding data blocks of a (particular) data block of the distributed database system” may refer to the data block of the distributed database system which directly precedes a (particular) data block, in particular. Alternatively, “preceding data blocks of a (particular) data block of the distributed database system” may refer to all data blocks of the distributed database system which precede the particular data block. As a result, the chaining checksum or the transaction checksum, for example, may be formed only over the data block (or its transactions) directly preceding the particular data block or over all data blocks (or their transactions) preceding the first data block.

A “blockchain node”, a “node”, a “node of a distributed database system” and the like may refer to devices (e.g., field devices, mobile telephones), computers, smartphones, clients, or subscribers which carry out operations using the distributed database system (e.g., a blockchain). Such nodes may carry out transactions of a distributed database system or the data blocks thereof, for example, or may insert or chain new data blocks containing new transactions into the distributed database system by new data blocks. In particular, this validation and/or chaining may be carried out by a trusted node (e.g., a mining node) or exclusively by trusted nodes. A trusted node is, for example, a node having additional security measures (e.g., firewalls, access restrictions to the node or the like) in order to prevent tampering with the node. Alternatively or additionally, when chaining a new data block to the distributed database system, a trusted node may store a node checksum (e.g., a digital signature or a certificate) in the new data block, for example. This makes it possible to provide, in particular, proof which indicates that the corresponding data block was inserted by a particular node and indicates its origin. The devices (e.g., the corresponding device) are, for example, devices of a technical system and/or an industrial installation and/or an automation network and/or a manufacturing plant which are also a node of the distributed database system, in particular. In this case, the devices may be field devices, for example, or devices in the Internet of Things which are also a node of the distributed database system, in particular. Nodes may also include at least one processor in order to carry out their computer-implemented functionality, for example.

A “blockchain oracle” and the like may refer to nodes, devices, or computers having, for example, a security module which, for example, by software protective mechanisms (e.g., cryptographic methods), has mechanical protective devices (e.g., a housing which may be closed) or electrical protective devices (e.g., tamper protection or a protective system which includes deletes the data in the security module in the event of impermissible use/handling of the blockchain oracle). In this case, the security module may include cryptographic keys which are needed to calculate the checksums (e.g., transaction checksums or node checksums).

A “computer”, an “apparatus”, or a “device” may refer to a computer (system), a client, a smartphone, a device, or a server which are each arranged outside the blockchain or are not a subscriber of the distributed database system (e.g., the blockchain) (that is to say do not carry out any operations using the distributed database system or only query it without carrying out transactions, inserting data blocks or calculating proof of work). Alternatively, a computer may refer to a node of the distributed database system. In other words, a device may refer to a node of the distributed database system or else a device outside the blockchain or the distributed database system. A device outside the distributed database system may access the data (e.g., transactions or control transactions) of the distributed database system and/or may be controlled by nodes (e.g., by smart contracts and/or blockchain oracles), for example. If, for example, a device (e.g., a device in the form of a node or a device outside the distributed database system) is controlled by a node, this may be carried out by a smart contract, for example, which is stored, in particular, in a transaction of the distributed database system.

A method for controlling a data network with respect to use of a distributed database is provided within the scope of the present disclosure. In this case, the method includes capturing capacities of computing resources of computing units of the data network. In this act, the utilization of the computing units of the data network, in particular, may be captured in order to determine free capacities for the use of the distributed database. In order to carry out this act, all computing units which are already present in the data network may be analyzed, for example, in order to capture free unused capacities of these computing units. For each computing unit with free unused capacities, it is then possible to check whether the respective computing unit may provide sufficient power to manage or operate the distributed database virtually additionally or secondarily.

The method further includes controlling the operation of the data network with respect to the use of the distributed database on the basis of the previously captured capacity of computing resources. In this act, it is possible to decide, in particular on the basis of the utilization of the computing units of the data network, whether the previously captured free capacities suffice to set up a distributed database in order to statistically represent a predetermined minimum security or target security, in particular using the distributed database which has been set up.

Setting up a distributed database (e.g., a blockchain-based database) makes it possible to provide the integrity of the data network, in particular the integrity of the data or data blocks stored in the data network. As a result, tampering with data of the data network by external attackers or by internal attackers may be advantageously detected in good time.

Data which are used to provide the integrity of the data network (e.g., a blockchain) may be stored at different spatially separate locations (e.g., even across a DMZ) using the distributed database. The computing units which implement the distributed database may compare these data with one another, thus ensuring that these data at the different spatially separate locations are identical. In the event of tampering with particular data in the distributed database (e.g., in the event of tampering with one of these blockchains), it would be detected that the other data in the distributed database (e.g., the other blockchains) include a different item of information, whereupon the data which have been tampered with (e.g., the blockchain which has been tampered with) are compared with the other data (e.g., the other blockchains), thus reversing the tampering.

According to one embodiment, control of the operation of the data network may include assigning computing tasks in connection with the storage of data in the distributed database to those computing units for which free capacities have been captured.

These computing tasks may include tasks for generating the data stored in the distributed database (e.g., the generation of a blockchain).

Control of the operation of the data network may also include assigning computing tasks for activating the distributed database to those computing units for which free capacities have been captured.

As a result, it is possible to automatically activate the distributed database if sufficiently free capacities are available in the computing units of the data network. Data integrity is therefore advantageously provided virtually automatically in an existing data network.

According to one embodiment, the operation of the data network is controlled on the basis of a predefined correlation between security of data stored in the distributed database and computing resources for storing the data in the distributed database.

The security or integrity of the data stored in the distributed database may depend, in particular, on how these data have been or are protected from tampering. Such protection may be implemented, for example, by appropriate encryption or by distributing as many copies as possible of the stored data within the database or the data network. The computing resources needed to provide this security may be determined on the basis of the security of the data stored in the distributed database or on the basis of the manner in which this security is implemented. In this case, there may be the trend that, the more computing resources are needed to store the data in the distributed database, the greater the security of the data stored in the distributed database, in which case this relationship (between the security of the data and the required computing resources) corresponds to the predefined correlation.

In this case, the security of the data may be changed, for example, by changing configuration parameters of one or more security features of the distributed database when storing the data. These configuration parameters determine, in particular, how the data stored in the distributed database are protected from tampering.

For example, the one or more security features may include a chaining checksum of sequentially stored data. For example, the length and/or the algorithm for forming the chaining checksum may be provided as a security feature.

If the distributed database is a blockchain-based database, each block of the blockchain may contain a cryptographically secure hash value of the respective preceding block, which may be considered to be the chaining checksum in the sense of the present disclosure. In other words, different data blocks which are stored in the distributed database are linked to one another by a chaining checksum in such a manner that it is (virtually) impossible to change only one of these data blocks without this being able to be noticed on the basis of the chaining checksum.

In addition, the operation of the data network may be controlled in a manner dependent on a comparison between the security of the data which is indicated on the basis of the predetermined correlation for the captured capacity of computing resources and a predefined target security or minimum security.

The minimum security may define, for example, how much effort is used to store a particular volume (e.g., 1 MB) of stored raw data (in the data network) in such a manner that unauthorized tampering with these raw data is at least detected. The minimum security therefore defines, in particular, the manner in which these raw data are protected from unauthorized tampering (e.g., encryption of the raw data or forming a checksum over the raw data), for example. If the security is implemented, for example, by a blockchain, the definition of the minimum security may also include how many copies of the blockchain exist and how these copies of the blockchain may be distributed in the distributed database.

The method may also include capturing a network topology (of the computing units) of the data network, with the result that the operation of the data network may be controlled in a manner dependent on this network topology.

The network topology may describe an arrangement of different computing units with respect to one another in the data network, that is to say communication coupling with or without interposed routers, etc.

On the basis of the current network topology of the data network and the current utilization of the computing units, wherein existing DMZs and local deployments of the data network are taken into account, it is possible to propose or control the locations at which computing units of the data network are to be used to operate the distributed database. In this case, the local deployments are understood as meaning which sites (for instance factories, business premises, outposts, etc.) are part of the data network and which fire protection zones, switch boxes and power supply sections etc. exist at a site with respect to the data network.

In this case, in some examples, control of the operation of the data network also includes adapting the network topology, in particular.

Adaptation of the network topology may include adding connections between computing units of the data network or removing connections between such computing units.

In addition, control of the operation of the data network may include adding and removing computing units from the data network.

If the assessment of the data network, in particular with respect to the free capacity of the computing resources of the computing units of the data network, reveals that this free capacity does not suffice to implement the predefined minimum security, e.g., using the distributed database to be generated, the method may suggest how many computing units may be added to the data network (e.g., as blockchain managers) at particular locations in order to be able to statistically achieve the predefined minimum security, in particular.

In this respect, control of the operation of the data network may include outputting user instructions via a user interface, wherein these user instructions relate to physical adaptations of the data network.

On the basis of these user instructions, it is possible to communicate with users of the data network in order to thereby carry out, in particular, the adaptations needed to achieve the minimum security (e.g., adding computing units and connections between computing units).

When using the method, the user may indicate what minimum security (level of security) the user would like to achieve by the distributed database. After the assessment of the data network (e.g., determination of the free capacities of the computing units), the method may then inform the user how many additional computing units or computing units and/or network investment (e.g., additional data connections) need to be added at which locations of the data network so that the minimum security strived for may be achieved using the distributed database expanded in this manner. The method may be used when planning a new data network, to expand an existing data network with the distributed database and to expand an existing data network having an already existing distributed database.

If the data network already has a distributed database, subsequent analyses in the event of an expansion or conversion of the data network may be provided in order to expand the distributed database further (e.g., an existing blockchain) or to maintain or expand the minimum security to be achieved. In this case, computing resources (e.g., CPU powers) which become free or newly added computing resources may be additionally automatically detected, e.g., by a continuously repeating check of the data network, and may be used to expand the distributed database.

Data which indicate operating parameters of the data network are stored in the distributed database, in particular.

By virtue of data which are derived from operating parameters of the data network being stored in the distributed database (e.g., in the blockchain), the distributed database may be advantageously used to detect whether these operating parameters have been impermissibly changed.

The data which are stored in the distributed database and indicate the operating parameters of the data network include, for example, versioning information of software or data packets stored in the data network.

As a result, any version change of this software or of these data packets (e.g., files) results in a corresponding change in the distributed database. As a result, any corresponding version change may be checked on the basis of the distributed database (e.g., blockchain), with the result that unauthorized (version) changes may be detected.

The distributed database (e.g., blockchain) may also be used to capture unauthorized tampering with all updates of the computing units (firmware) present in the data network as well as of other software and data which are used, utilized, or sent and therefore to increase the security strived for to a high level.

An item of information (e.g., blockchain information) stored in the distributed database may also be linked to data to be transmitted in the data network in order to thus provide the integrity of these data during processing or transmission to an external memory (e.g., cloud).

However, it may be possible to store data which themselves have information content other than the operating parameters of the data network in the distributed database. It would be possible, for instance, to store data in the distributed database which relate, for instance, to measured values from sensors which are connected to the data network.

In this case, multifunctional platforms having a plurality of cores, (e.g., CPUs and/or GPUs), may be used as computing units for the database.

These multifunctional platforms which have a plurality of cores may be used to advantageously reduce the network load in comparison with other platforms. For example, a so-called blockchain computing unit (that is to say a computing unit for managing a blockchain) may be implemented on any unused core or on all available cores of such a multifunctional platform. A substantially lower network load advantageously occurs as a result of the data traffic between the cores of the same multifunctional platform in comparison with data traffic between computing units distributed in the network.

It is possible for particular computing units of the data network which are used for the distributed database to manage only one part of the blockchain, wherein this part includes at least the last block of the blockchain.

In order to reduce the network load and the effort needed to manage the blockchain, a hierarchy may be put into the blockchain organization. According to this hierarchy, a first hierarchical level has blockchain managers which manage only the at least necessary appendix or the previously described part of the blockchain which is needed to generate a new block for the blockchain. A second hierarchical level above the first hierarchical level has blockchain managers each including the entire blockchain. The network load and also the storage requirements for storing the blockchain may be reduced by the blockchain managers in the first hierarchical level without having to sacrifice the security of the data network.

It is possible to change a procedure for determining, on the basis of a particular block of the blockchain, a hash value which indicates the particular block and is stored in a further block of the blockchain which directly follows the particular block.

The possibility of changing the procedure for determining or generating the hash value for the blockchain advantageously makes it possible to further increase the security of the data network which is achieved by the distributed database.

The data network may be an industrial data network which may be used, for example, for an automotive company, a track system, a power plant, a smart grid or a power transmission system. Maintenance data, cloud data, or health data may be stored using a data network.

A further method for assessing a data network with respect to use of a distributed database (e.g., blockchain) may also be provided within the scope of the present disclosure. This further method includes capturing a capacity of computing resources of a multiplicity of computing units of the data network. In this act, free capacities of the computing resources for the use of the distributed database are determined, in particular.

This further method also includes assessing the data network with respect to the use of the distributed database on the basis of the previously captured capacity. In this act, the data network is assessed, in particular, assuming that the previously determined free capacities are used for the distributed database.

The further method need not necessarily include control of the operation of the data network, but rather may output the determined assessment of the data network as information, for example, with the result that the use of the distributed database in the data network may then be planned on the basis of this information in order to provide the integrity of the data stored in the data network through the use of the distributed database.

If it is detected that the captured capacity of computing resources meets the technical requirements for setting up a distributed database (e.g., a blockchain) in the data network, appropriate software packages may be automatically loaded onto the computing units of the computing units and the distributed database may thereby be activated. This may be initiated, for example, by a corresponding user by accordingly pressing a button or by an appropriate slider or tick in a software menu. If hardware expansions of the data network are detected, the distributed database may be automatically expanded with additional blockchain managers (that is to say new computing units in the data network) and the security may therefore be increased. Such an expansion may take place, on the one hand, by introducing extra computing units for the blockchain or by additional installations in the data network which may concomitantly undertake some of the blockchain tasks.

An apparatus for controlling a data network with respect to use of a distributed database is also provided within the scope of the present disclosure. In this case, the apparatus includes computing units or devices and a connection for connecting the apparatus to the data network. The apparatus is configured to capture a capacity of computing resources of a multiplicity of computing units of the data network and to control the operation of the data network with respect to the use of the distributed database on the basis of the previously captured capacity of computing resources.

The advantages of the apparatus correspond substantially to the advantages of the method which have been stated in detail above, with the result that a repetition is dispensed with here.

The present disclosure also describes a computer program product, in particular software, which may be loaded into a memory of a programmable control device or a computing unit which may be connected to a data network. This computer program product may be used to carry out all or different previously described embodiments of the method when the computer program product runs in the control device. In this case, the computer program product may include program modules or code, e.g., libraries and auxiliary functions, to implement the corresponding embodiments of the method. In other words, the claim directed to the computer program product is intended to protect, in particular, software which may be used to carry out one of the above-described embodiments of the method or which carries out this embodiment. In this case, the software may be a source code (e.g., C++) which still has to be compiled and linked or only has to be interpreted, or may be an executable software code which, for execution, only needs to be loaded into the corresponding computing unit or control device.

Finally, the present disclosure discloses an electronically readable data storage medium, e.g., a DVD, a magnetic strip, a hard disk, or a USB stick, on which electronically readable control information, in particular software (cf. above), is stored. If this control information (software) is read from the data storage medium and is stored in a control device or computing unit which may be connected to a data network, all embodiments of the method described above may be carried out.

The security achieved by a blockchain may be gradually integrated into an existing data network, e.g., using central software. The disclosure may be used both in the planning phase and in an already existing data network without a blockchain and in an existing data network with a blockchain. By improving the quality of the blockchain used, the quality or integrity of the data network may also be improved or may be gradually configured to particular conditions. For example, if enlarging the data network, a notice may be automatically generated indicating that additional security with respect to the blockchain may be installed. A distributed database (e.g., a blockchain) may be implemented in a cost-optimized manner by using existing computing units and/or by suggestions for placing new computing units or for deploying existing computing units and for rolling out the distributed database.

### BRIEF DESCRIPTION OF THE DRAWINGS

The present disclosure is described in detail below on the basis of embodiments with reference to the figures.

FIG. 1 schematically illustrates a blockchain according to an embodiment.

FIG. 2 illustrates an example of an apparatus connected to a data network.

FIG. 3 illustrates an example of the data network illustrated in FIG. 2 with a distributed database.

### DETAILED DESCRIPTION

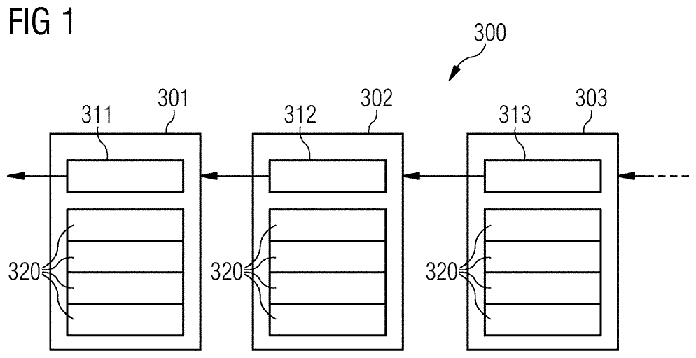

FIG. 1 schematically illustrates a blockchain 300. The blockchain 300 includes a plurality of data blocks 301-303 which are linked in the form of a chain or sequence of data blocks 301-303. Each data block 301-303 has a chaining checksum 311-313 which represents a hash value, for example. The checksum 311-313 is determined on the basis of the respective preceding data block within the blockchain or within the sequence of data blocks 301-303. For example, the checksum 312 of the data block 302 is formed on the basis of the data block 301, which is represented by the corresponding arrow in FIG. 1. The checksum 311 or 312 of the data block 301 or 302 may be a hash value which is calculated on the basis of the data stored in the respective preceding data block 302 or 303. As a result, an (e.g., unauthorized) modification of the data block 302 or 303 may be captured by comparing the data block 302 or 303 with the checksum 311 or 312.

Transactions 320 may be stored in each data block 301-303. Each transaction 320 may include corresponding data or may refer to corresponding data by storing a corresponding reference or a corresponding item of additional information or a corresponding checksum etc.

The data (e.g., transactions 320) stored in the data blocks 301-303 may include version information relating to software or data packets stored in a data network. As a result, the blockchain 300 protects against an unauthorized modification of the version information within the data network protected by the blockchain 300.

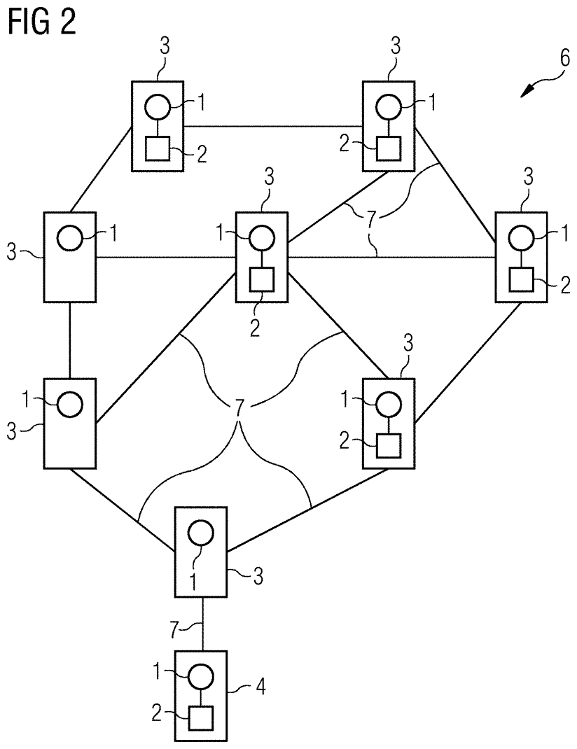

FIG. 2 illustrates a data network 6, to which an apparatus 4 is connected.

The data network includes a plurality of computing units 3 which each include at least one CPU 1, and which may also include a storage unit or a memory 2. The computing units 3 are connected to one another via data lines 7. The apparatus 4 is likewise a computing unit which includes a CPU 1 and a storage unit or a memory 2. The apparatus 4 is connected to the data network 6 via a data line 7 or is part of the data network 6.

A method for controlling the data network with respect to use of a distributed database (e.g., a blockchain 300) runs on the apparatus 4. The method captures a capacity of computing resources of the computing units 3 of the data network 6. The apparatus 4 controls the operation of the data network 6 with respect to the use of the distributed database 300 on the basis of this capacity of computing resources.

In the case illustrated, the apparatus 4 detects that three computing units 3 of the data network 6 have sufficiently free capacities to generate a distributed database 300 using these three computing units 3.

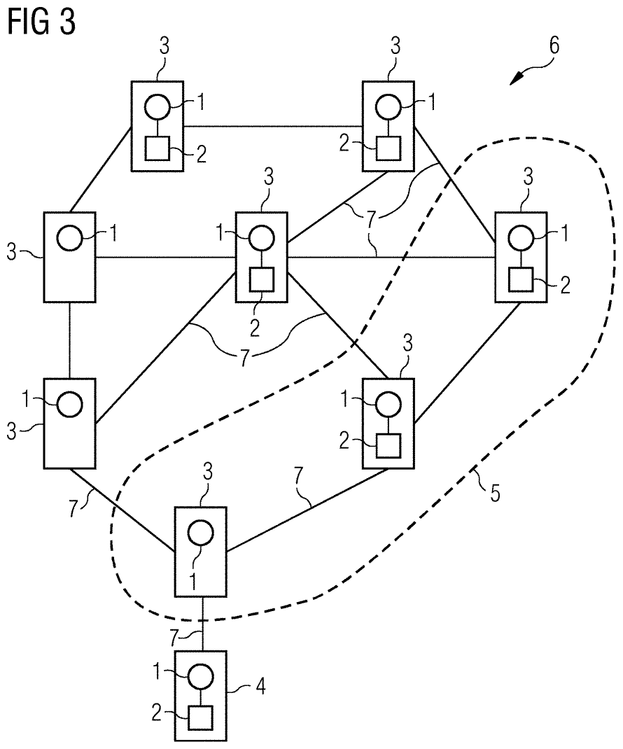

In FIG. 3, these three computing units 3 are combined by a dashed line 5, wherein the computing units 3 used for the distributed database (in particular in order to implement a blockchain 300) are marked using the reference sign 5. The apparatus 4 sets up the distributed database 300 with the aid of these three computing units 3, which database then stores version information for the software and data packets stored in the data network 6 in the form of a blockchain. As a result, the distributed database or blockchain 300 set up provides data integrity of the data network 6.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for controlling a data network with respect to use of a distributed database, the method comprising:
capturing a capacity of computing resources of a multiplicity of computing units of the data network; and
controlling an operation of the data network with respect to the use of the distributed database based on the capacity of computing resources.

2. The method of claim 1, wherein the controlling of the operation of the data network comprises:
assigning computing tasks in connection with storage of data in the distributed database to one or more computing units of the multiplicity of computing units.

3. The method of claim 1, wherein the controlling of the operation of the data network comprises:
assigning computing tasks in connection with activation of the distributed database to one or more computing units of the multiplicity of computing units.

4. The method of claim 1, wherein the operation of the data network is controlled based on a predefined correlation between (i) security of data stored in the distributed database and (ii) computing resources for storing the data in the distributed database.

5. The method of claim 4, wherein the security of the data is changed by changing configuration parameters of one or more security features of the distributed database when storing the data.

6. The method claim 5, wherein the one or more security features comprise a chaining checksum of sequentially stored data.

7. The method of claim 4, wherein the operation of the data network is controlled based on a comparison between (i) the security of the data which is indicated based on the predefined correlation for the captured capacity of computing resources and (ii) a predefined target security.

8. The method of claim 1, further comprising:
capturing a network topology of the computing units of the data network,
wherein the controlling of the operation of the data network is also dependent on the network topology of the data network.

9. The method of claim 8, wherein the controlling of the operation of the data network comprises adapting the network topology.

10. The method of claim 1, wherein the controlling of the operation of the data network comprises adding or removing computing units from the data network.

11. The method of claim 1, wherein the controlling of the operation of the data network comprises:
outputting user instructions relating to a physical adaptation of the data network via a user interface.

12. The method of claim 1, wherein data indicating operating parameters of the data network are stored in the distributed database.

13. The method of claim 12, wherein the data stored in the distributed database indicate version information of software of the computing units.

14. The method of claim 1, wherein multifunctional platforms having a plurality of cores are used as computing units for the database.

15. An apparatus for controlling a data network with respect to use of a distributed database, the apparatus comprising:
a computing unit and a connection for connection to the data network (6),
wherein the apparatus is configured to capture a capacity of computing resources of a multiplicity of computing units of the data network and to control an operation of the data network with respect to the use of the distributed database based on the capacity of computing resources.

16. The apparatus of claim 15, wherein the apparatus is further configured to:
capture a network topology of the computing units of the data network,
wherein the control of the operation of the data network is dependent on the network topology of the data network.

17. A computer program product which comprises a program and configured to be directly loaded into a memory of a programmable apparatus connected to a data network, wherein the computer program product, when executed in the apparatus, causes the apparatus to:
capture a capacity of computing resources of a multiplicity of computing units of the data network, and
control an operation of the data network with respect to a use of a distributed database based on the capacity of computing resources.

18. (canceled)
